(19) United States
(12) Patent Application Publication
(10) Pub. No.: US 2014/0123437 A1
(43) Pub. Date: May 8, 2014

(54) FASTENER ASSISTANCE DEVICE

(71) Applicant: PETER HANSON, Huntington Beach, CA (US)

(72) Inventor: PETER HANSON, Huntington Beach, CA (US)

(21) Appl. No.: 13/672,620

(22) Filed: Nov. 8, 2012

(51) Int. Cl. A47G 25/92; G09F 3/00

(52) U.S. Cl. CPC A47G 25/92; G09F 3/00
USPC 24/40; 40/299.01

(57) ABSTRACT

A fastener assistance device comprising an elongated shank having a first end and an opposite second end and a first clip containing a first inner surface configured for selective securement of a button and/or similar like fastener.

### INCORPORATION BY REFERENCE

Applicant(s) hereby incorporate herein by reference any and all U.S. patents and U.S. patent applications cited or referred to in this application.

### BACKGROUND OF THE INVENTION

1. Field of the Invention

Aspects of this invention relate generally to a fastener assistance device and more particularly, to a fastener assistance device and method which facilitates insertion of a button through a button hole to aid the user in buttoning up a shirt and/or collar.

2. Description of Related Art

The following art defines the present state of this field:

Currently there are no known fastener assistance devices or corresponding methods that have the ability to aid a user in facilitating a button or button-like fastener through a button hole to more conveniently and easily button on shirt collars and sleeves.

### SUMMARY OF THE INVENTION

Clothing apparel comes in a variety of shapes and sizes for both men and women. The standard coupling mechanism for many clothing apparel is via a fastener such as a button. For the purposes of this application, the inventor uses the example of a button on a shirt to represent a fastener but acknowledges that any button-like fastener is also within the scope of this invention. Depending on the shape and size of the clothing apparel, buttons also come in many shapes and sizes depending on the need and style. Buttons are most often attached to articles of clothing but can also be used on containers such as wallets and bags. Buttons serving as fasteners work by slipping through a fabric or thread loop or by sliding through a buttonhole.

The standard size of a regular shirt button typically is 16 lignes or 10.16 mm and 32 lignes or 20.32 for a typical suit jacket. In addition, a typical shirt can include anywhere from 5 to 10 buttons for the chest and then additional buttons for the sleeves. Facilitating or slipping a button through a corresponding button-hole can be often time consuming and tedious for users who regularly wear shirts daily for their business or casual activities. Moreover, users with finger or hand disabilities are faced with more tedious challenges when trying to facilitate a button through a corresponding button-hole. The inventor has created a fastener assistance device which addresses the issues stated above. Moreover, the fastener assistance device includes an advertising means which allows individuals/companies an avenue for marketing/advertising directly on the fastener assistance device.

Aspects of the present invention teach certain benefits in construction and use which give rise to the exemplary advantages described below.

In an exemplary embodiment of the invention, fastener assistance device comprising an elongated shank having a first end and an opposite second end and a first clip containing a first inner surface configured for selective securement of a button and/or similar like fastener.

A primary objective inherent in the above-described apparatus and method of use is to provide advantages not taught by the prior art.

Other features and advantages of aspects of the present invention will become apparent from the following more detailed description, taken in conjunction with the accompanying drawings, which illustrate, by way of example, the principles of aspects of the invention.

### BRIEF DESCRIPTION OF THE DRAWINGS

The accompanying drawings illustrate aspects of the present invention. In such drawings:

FIG. 1 is a perspective view of an exemplary embodiment of the inventive subject matter;

FIG. 2 is a side view of an exemplary embodiment of the inventive subject matter;

FIG. 3 is a top down view of an exemplary embodiment of the inventive subject matter;

FIG. 4 is a perspective view of an alternate exemplary embodiment of the inventive subject matter;

FIG. 5 is a side view of an alternate exemplary embodiment of the inventive subject matter;

FIG. 6 is a top down view of an alternate exemplary embodiment of the inventive subject matter;

FIG. 7 is a perspective view of an alternate exemplary embodiment of the inventive subject matter;

FIG. 8 is a side view of an alternate exemplary embodiment of the inventive subject matter;

FIG. 9 is a top down view of an alternate exemplary embodiment of the inventive subject matter;

FIG. 10 is a perspective view of an alternate exemplary embodiment of the inventive subject matter;

FIG. 11 is a side view of an alternate exemplary embodiment of the inventive subject matter;

FIG. 12 is a top down view of an alternate exemplary embodiment of the inventive subject matter;

FIG. 13 is a perspective view depicting the fastener assistance device of the inventive subject matter being secured to a button or fastener-like item;

FIG. 14 is a perspective view depicting a method for inserting a button through a button hole involving the fastener assistance device of the inventive subject matter being secured to a button or fastener-like item and being pulled through the corresponding button or fastener-like hole;

FIG. 15 is a perspective view depicting a method for inserting a button through a button hole involving the fastener assistance device of the inventive subject matter after it has been pulled through the corresponding button or fastener-like hole;

FIG. 16 is a perspective view depicting a method for inserting a button through a button hole involving the fastener assistance device of the inventive subject matter being removed from the button after it has been pulled through the corresponding button or fastener-like hole.

Features, elements, and aspects of the invention that are referenced by the same numerals in different figures represent the same, equivalent, or similar features, elements, or aspects, in accordance with one or more embodiments.

### DETAILED DESCRIPTION OF THE INVENTION

The above described drawing figures illustrate aspects of the invention in at least one of its exemplary embodiments, which are further defined in detail in the following description.

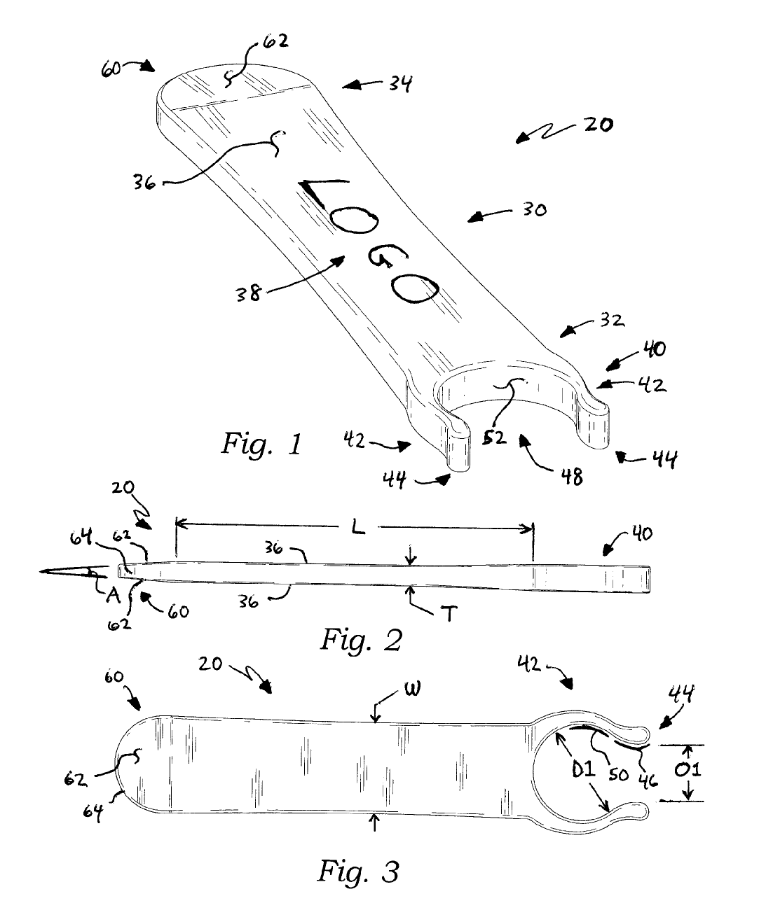

Turning now to FIG. 1, there is shown a perspective view of an exemplary embodiment of a fastener assistance device 20 comprising a shank 30, a first end 32, a second end 34, a shank surface 36, advertising means 38, a first clip 40, a second clip 42, a first leg tip 44, a first button receptacle 48, and a first inner surface 52. In one preferred embodiment, the fastener assistance device apparatus 20 contains an introducer 60 and introducer surface 62 which allows the user to grab and/or hold when manipulating the fastener assistance device apparatus 20. In one preferred embodiment, the a first clip 40 is formed at the first end 32 having at least one resilient curved first leg 42 transitioning to and cooperating with the shank 30 to form a first button receptacle 48. The first leg 42 terminating distally in a substantially rounded first leg tip 44 having a first tip arc sense 46 that is opposite of the first receptacle arc sense 50 (not shown) so as to form a first inner surface 52 of the first clip 40 defining a first S-curve profile and configured for selective securement of the button therein, whereby securement of the button within the first button receptacle 48 of the first clip 40 and subsequent passage of the fastener assistance device 20 through the corresponding button or fastener-like hole, beginning with the second end 34 and following with the shank 30 and the first end 32, serves to conveniently pull the button or fastener-like member through the button or fastener-like hole. In practical usage, the first tip arc sense 46 of the first leg tip 44 flexes or widens open upon initial contact of a button or fastener-like member to allow the button to fit securely within the first button receptacle 48. Upon the removal, the first tip arc sense 46 of the first leg tip 44 flexes or widens open to allow for the first button receptacle 48 to release the button from the fastener assistance device 20. In one preferred embodiment, the fastener assistance device 20 is manufactured from a plastic or similar material that is sturdy but yet pliable and allows for inexpensive manufacturing and production. In one preferred embodiment, the fastener assistance device 20 contains an advertising means 38 comprising of a graphical indicia placed on the shank 30 surface.

A side view of the exemplary embodiment of a fastener assistance device 20 is shown in FIG. 2, where the shank 30 is configured having a length L-to-width W aspect ratio of three-to-one (3:1) and a width W-to-thickness T aspect ratio of four-to-one (4:1) so as to form opposite substantially rectangular, substantially planar shank surfaces. In one preferred embodiment, the thickness of the shank 30 between the opposite shank surfaces 36 is approximately one-eighth inch (⅛″) and wherein the introducer 60 comprises of an acute introducer angle A which terminates in a rounded introducer leading edge 64 that may be tapered.

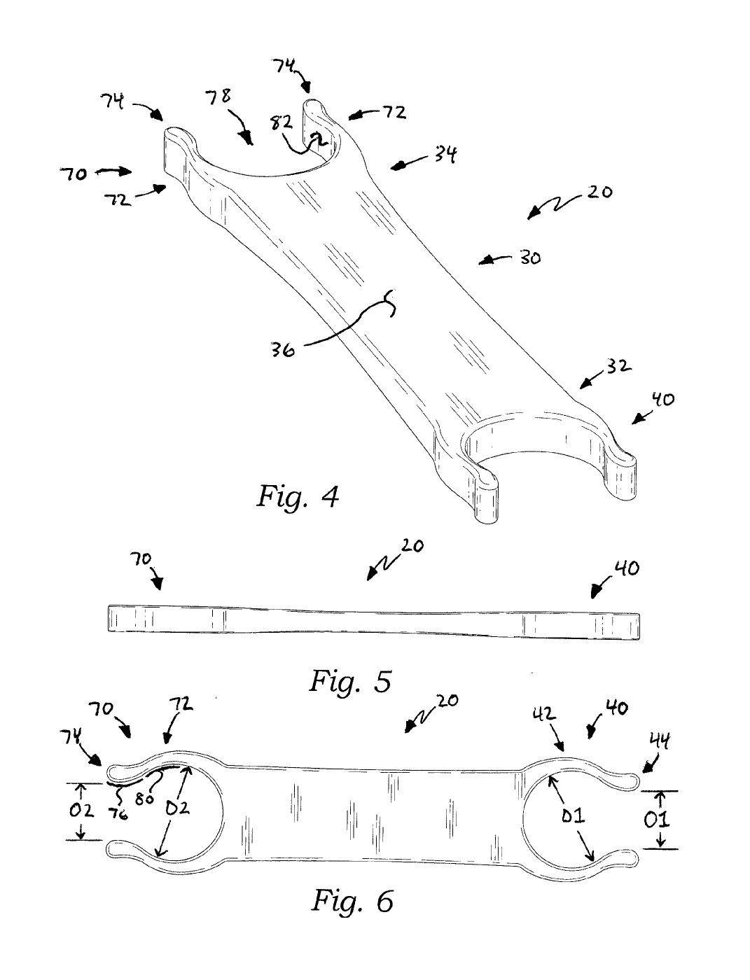

With continued reference to FIG. 3, the top down view of the exemplary embodiment of the fastener assistance device 20 is seen wherein the first opening O1 is approximately one-quarter inch (¼″) and the first nominal diameter D1 is approximately one-half inch (½″). Here again, the first tip arc sense 46 and first tip receptacle arc sense 50 form a first inner surface 52 of the first clip 40 which secures the button or fastener-like member. FIGS. 4-5 show an alternative exemplary embodiment of the fastener assistance device 20 having two opposite, somewhat parallel first legs, each such first leg having an opposing first S-curve profile so as to symmetrically form and bound the first button receptacle and define the first inner surface of the first clip. The fastener assistance device 20 further comprising a second clip 70 formed at the second end having at least one resilient curved second leg 72 transitioning to and cooperating with the shank 30 to form a second button or fastener-like receptacle 78. The second leg 72 terminating distally in a substantially rounded second leg tip 74 having a second tip arc sense 76 that is opposite of the second receptacle arc sense 80 so as to form a second inner surface 82 of the second clip 70 defining a second S-curve profile configured for selective securement of a button or fastener-like member inside the second button receptacle 78. The second tip arc sense 76 of the second leg tip 74 functions similarly as the exemplary embodiment shown in FIG. 4 wherein upon contact flexes or widens open to attach and release a button or fastener-like member from the second inner surface 82 (as shown in FIG. 4).

FIG. 6 depicts the alternative exemplary embodiment of the fastener assistance device 20 shown in FIGS. 4 and 5 wherein the first nominal diameter D1 is substantially twice the size of the first opening O1 and second nominal diameter D2 is substantially twice the size of the second opening O2. In a preferred alternate exemplary embodiment, the first and second openings (O1 and O2) are substantially equal and the first and second nominal diameters (D1 and D2) are substantially equal.

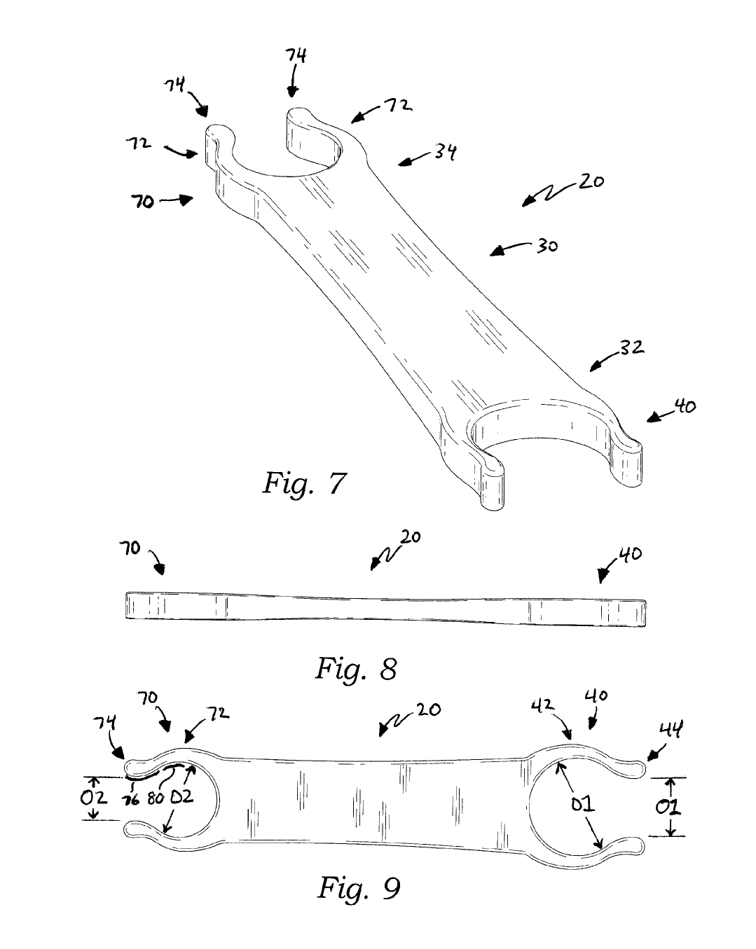

Turning to FIGS. 7-9, a fastener assistance device 20 is shown having a first clip 40 and a second clip 70 wherein the first clip 40 wherein the first opening O1 and first diameter D1 of the first clip 40 is larger than the second opening O2 and second diameter D2 opening of the second clip 70. In one preferred exemplary embodiment the first opening O1 is one-quarter inch (¼″) and the first nominal diameter D1 is one-half inch (½″); and the second opening O2 is three-sixteenths inch ( 3/16″) and the second nominal diameter D2 is three-eighths inch (⅜″). This alternative exemplary embodiment allows for the ability of the fastener assistance device 20 to accommodate different button or fastener-like sizes and shapes including buttons on shirts and coats/jackets. The second tip arc sense 76 of the second leg tip 74 functions similarly as the exemplary embodiment shown in FIG. 4 wherein upon contact flexes or widens open to attach and release a button or fastener-like member from the second inner surface 82 (as shown in FIG. 4).

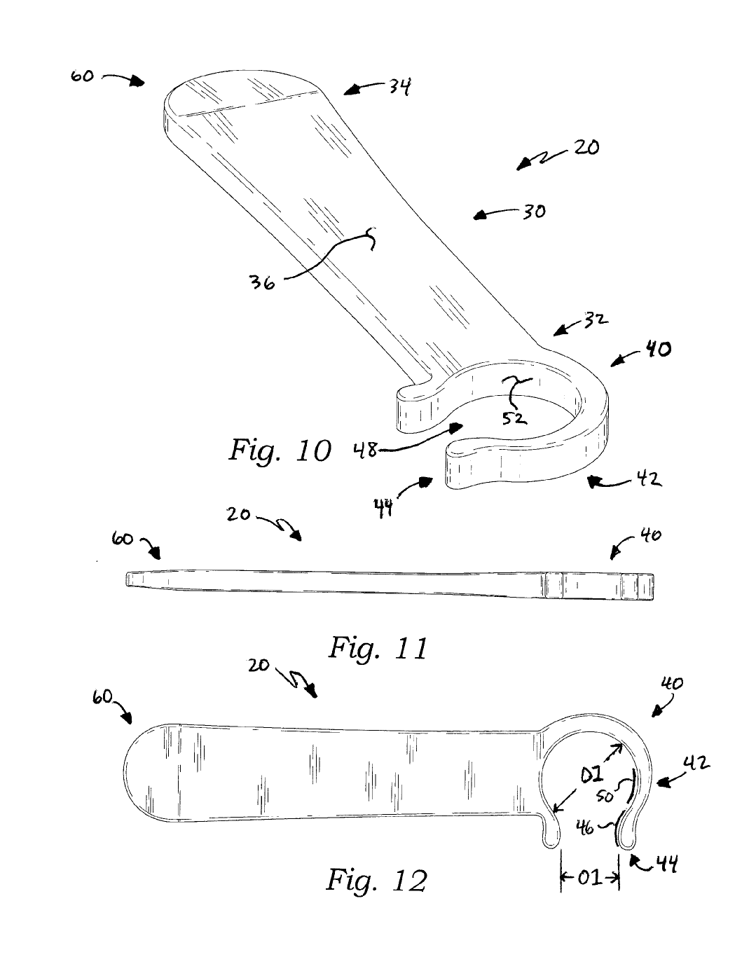

FIGS. 10-12 show yet another alternative exemplary embodiment of the fastener assistance device 20 comprising of a first clip 40 with a first leg 42, a first leg tip 44, a first button receptacle 48 and a first inner surface 52 for selectively securing a button or fastener-like member.

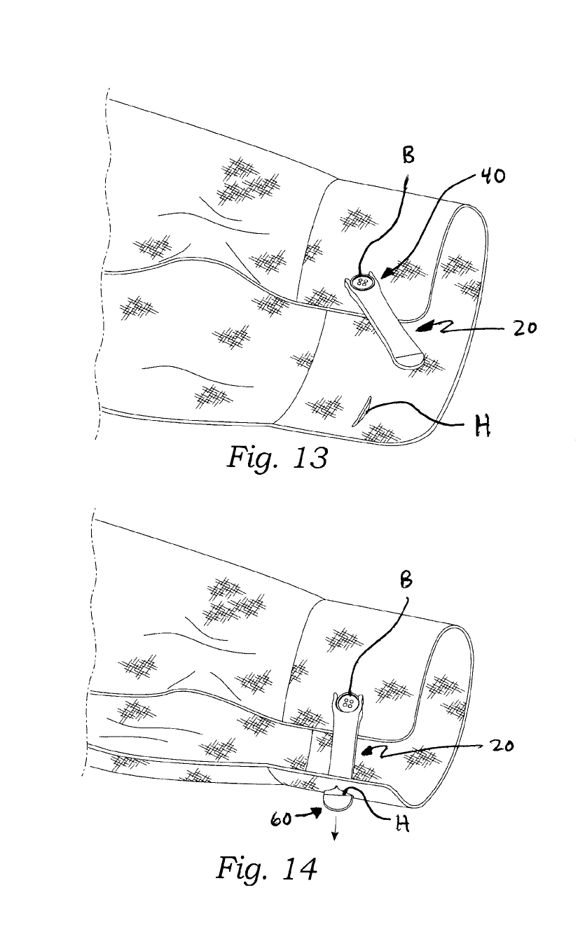

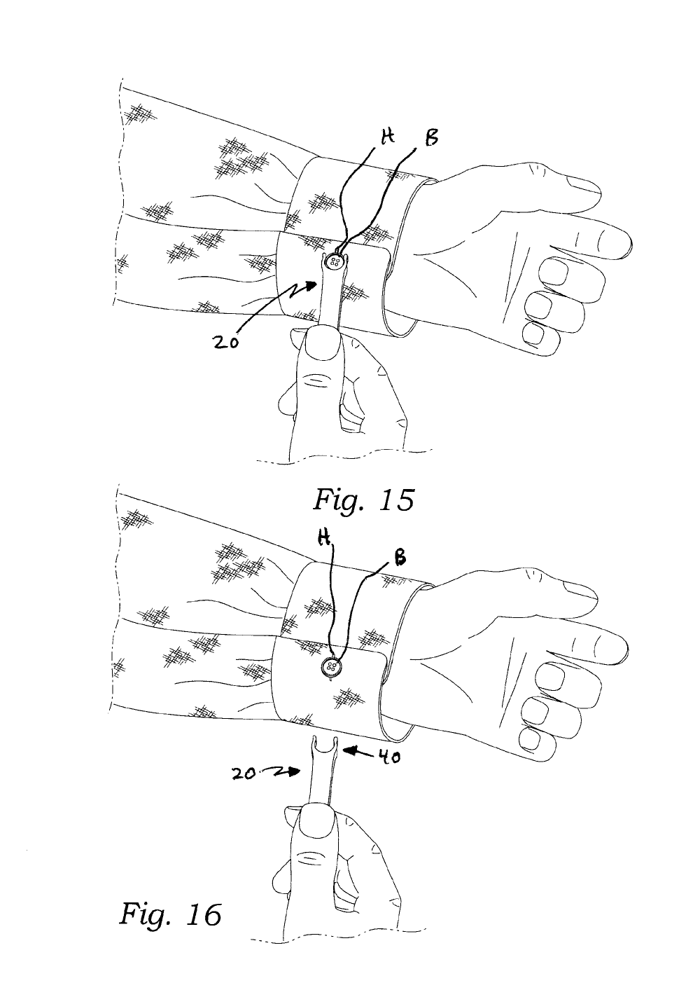

As clearly seen in FIGS. 13-16, a method is shown for inserting a button B through a button hole H comprising the steps of removably securing the button B within a first button receptacle of a first clip 40 at a first end 40 of a button or fastener-like assistance device 20, inserting an opposite second end 60 of the shank of the button or fastener-like assistance device into the button hole H and then successively passing the second end 60, the shank, and the first end 40 through the button hole H and then disengaging the button or fastener-like assistance device from the button leaving the button coupled to the former button hole.

While aspects of the invention have been described with reference to at least one exemplary embodiment, it is to be clearly understood by those skilled in the art that the invention is not limited thereto. Rather, the scope of the invention is to be interpreted only in conjunction with the appended claims and it is made clear, here, that the inventor(s) believe that the claimed subject matter is the invention.

1. A fastener assistance device for facilitating insertion of a button through a button hole, comprising:
an elongate shank having a first end and an opposite second end; and
a first clip formed at the first end having at least one resilient curved first leg transitioning to and cooperating with the shank to form a first button receptacle defining a first nominal diameter and having a first receptacle arc sense, the first leg terminating distally in a substantially rounded first leg tip having a first tip arc sense that is opposite of the first receptacle arc sense so as to form a first inner surface of the first clip defining a first S-curve profile and configured for selective securement of the button therein, whereby securement of the button within the first button receptacle of the first clip and subsequent passage of the button assistance device through the corresponding button hole, beginning with the second end and following with the shank and the first end, serves to conveniently pull the button through the button hole.

2. The device of claim 1 wherein the first clip is formed having two opposite, somewhat parallel first legs, each such first leg having an opposing first S-curve profile so as to symmetrically form and bound the first button receptacle and define the first inner surface of the first clip.

3. The device of claim 2 wherein:
a first opening is defined as the shortest at-rest distance between the first legs substantially between the respective first leg tips; and
the first nominal diameter is substantially twice the size of the first opening.

4. The device of claim 3 wherein the first opening is one-quarter inch (¼″) and the first nominal diameter is one-half inch (½″).

5. The device of claim 1 further comprising a tapered introducer formed at the second end.

6. The device of claim 5 wherein the introducer is configured having opposite planar introducer surfaces defining an acute introducer angle and terminating in a rounded introducer leading edge.

7. The device of claim 1 further comprising a second clip formed at the second end having at least one resilient curved second leg transitioning to and cooperating with the shank to form a second button receptacle defining a second nominal diameter and having a second receptacle arc sense, the second leg terminating distally in a substantially rounded second leg tip having a second tip arc sense that is opposite of the second receptacle arc sense so as to form a second inner surface of the second clip defining a second S-curve profile configured for selective securement of the button therein.

8. The device of claim 7 wherein:
the first clip is formed having two opposite, somewhat parallel first legs, each such first leg having an opposing first S-curve profile so as to symmetrically form and bound the first button receptacle and define the first inner surface of the first clip; and
the second clip is formed having two opposite, somewhat parallel second legs, each such second leg having an opposing second S-curve profile so as to symmetrically form and bound the second button receptacle and define the second inner surface of the second clip.

9. The device of claim 8 wherein:
a first opening is defined as the shortest at-rest distance between the first legs substantially between the respective first leg tips;
the first nominal diameter is substantially twice the size of the first opening;
a second opening is defined as the shortest at-rest distance between the second legs substantially between the respective second leg tips; and
the second nominal diameter is substantially twice the size of the second opening.

10. The device of claim 9 wherein:
the first and second openings are substantially equal; and
the first and second nominal diameters are substantially equal.

11. The device of claim 9 wherein:
the first opening is larger than the second opening; and
the first nominal diameter is greater than the second nominal diameter.

12. The device of claim 11 wherein:
the first opening is one-quarter inch (¼″) and the first nominal diameter is one-half inch (½″); and
the second opening is three-sixteenths inch ( 3/16″) and the second nominal diameter is three-eighths inch (⅜″)

13. The device of claim 1 wherein the shank is configured having a length-to-width aspect ratio of three-to-one (3:1) and a width-to-thickness aspect ratio of four-to-one (4:1) so as to form opposite substantially rectangular, substantially planar shank surfaces.

14. The device of claim 13 wherein the thickness of the shank between the opposite shank surfaces of one-eighth inch (⅛″).

15. The device of claim 13 further comprising graphical indicia placed on at least one of the shank surfaces.

16. A button assistance device for facilitating insertion of a button through a button hole, comprising:
an elongate shank having a first end and an opposite second end, the shank having a first clip formed at the first end configured for removable receipt of the button, the shank further having opposite substantially rectangular, substantially planar shank surfaces; and
means for advertising incorporated into at least one shank surface.

17. The device of claim 16 wherein the advertising means comprises graphical indicia placed on the at least one shank surface.

18. A method for inserting a button through a button hole, comprising the steps of:
removably securing the button within a first button receptacle of a first clip formed at a first end of an elongate shank of a button assistance device;
inserting an opposite second end of the shank of the button assistance device into the button hole; successively passing the second end, the shank, and the first end through the button hole, whereby the button is conveniently pulled through the button hole; and
disengaging the button assistance device from the button.
